(19) United States
(12) Patent Application Publication
(10) Pub. No.: US 2026/0087539 A1
(43) Pub. Date: Mar. 26, 2026

(54) GENERATING AN ITEM SELECTION SEQUENCE USING A MACHINE LEARNING MODEL FOR IDENTIFYING FOUNDATIONAL ITEMS

(71) Applicant: Maplebear Inc., San Francisco, CA (US)

(72) Inventors: Shaun Navin Maharaj, Vaughan (CA); Mark Oberemk, Toronto (CA); Brent Scheibelhut, Toronto (CA); Madeline Mesard, New York, NY (US)

(21) Appl. No.: 18/892,150

(22) Filed: Sep. 20, 2024

(51) Int. Cl. G06Q 30/0601; G06Q 30/0201

(52) U.S. Cl. CPC G06Q 30/0633; G06Q 30/0201; G06Q 30/0631

(57) ABSTRACT

An online system receives orders from users and fulfills the orders by dispatching a picker to a physical source to obtain the items for delivery. Some items in an order may be considered “foundational,” meaning that a user who ordered the items may wish to cancel one or more other items in the order if the foundational item is unavailable (e.g., the item is a critical ingredient for a recipe). The online system predicts items in the order that are foundational using a trained machine-learning model. The online system presents the items to the picker in a sequence so the foundational items are obtained earlier by the picker. This enables the picker to observe whether the determined foundational item is available sooner in the picking process, allowing earlier performance of a remedial action and possibly avoiding replacing previously obtained items affected by the unavailability of the foundational item.

### BACKGROUND

Various online systems offer items for acquisition by users, with an online system receiving a selection of one or more items from a user and facilitating delivery of the selected one or more items to the user. For example, the online system may allocate an order from a user to a picker, who obtains items from the source included in the order and delivers the obtained items to a location specified by the order.

One or more items included in an order created by a user may be more important than other items in the order. For example, the order includes multiple items for a recipe, with a particular item being the main ingredient for the recipe and other items being complementary to the particular item. If a picker is unable to obtain the particular item, the user is unable to successfully prepare the recipe and is more likely to be unsatisfied with fulfillment of the order by the online system, regardless of whether the picker obtains the other items in the order. Conversely, if the picker is able to obtain the particular item but is unable to obtain one or more other items complementing the particular item, the user is more likely to be satisfied with fulfillment of the order by the online system. However, the order created by the user does not identify which items are more important than other items, so the picker is unable to determine from the order which items in the order are more important than other items in the order.

When a picker fulfills an order from an online system, conventional online systems automatically generate a sequence in which the picker obtains items of the order to minimize a time spent by the picker obtaining the order. However, because the order does not include information identifying which items in an order are more important than other items in the order, sequences for obtaining items in an order generated by conventional online systems are unable to account for varying degrees of importance of different items in an order to each other when generating a sequence of items for the order. Although an order does not include information identifying which items are more important than other items, many online systems maintain information describing prior orders fulfilled for various users or other relationships between different items.

### SUMMARY

To address these problems, in one or more embodiments, an online system leverages the stored relationships between different items, as well as stored information about previously fulfilled orders, to train a model that identifies items in an order that are more important than other items. The system then determines sequence for picking items in the order that prioritizes the more important items, improving sequences for selecting items in various orders the online system generates.

In accordance with one or more aspects of the disclosure, an online system receives an order from a user including one or more items and identifying a source from which the one or more items are obtained. The order includes a location for delivering the one or more items in the order and may include a time interval for delivering the one or more items to the location. In various embodiments, the order initially sequences items in the order based on a time when the user selected the items for inclusion in the order, so items added to the order at earlier times have higher positions in the sequence.

One or more items included in the order may be “foundational items.” A foundational item is an item in the order that a picker fulfilling the order cannot fail to obtain when fulfilling the order. Inability to obtain a foundational item renders one or more other items in the order useless to the user from whom the order was received. Hence, a foundational item is an item in the order whose ability to be obtained determines whether fulfillment of the order is successful or is not successful to the user. A picker obtaining all the items in the order other than a foundational item would result in the user being unsatisfied with fulfillment of the order, as one or more other items depend on the foundational item for a purpose of the user for the order, making the one or more other items useless to the user without the foundational item. The order may include multiple foundational items in various embodiments, with different foundational items affecting different groups of items in the order. Some orders may not include a foundational item.

However, the order does not include information identifying which items are foundational items. Additionally, the picker fulfilling the order is unable to determine whether a foundational item in the order is available at the source until the picker begins fulfilling the order. So, a picker may obtain multiple other items in the order before observing that the foundational item of the order is unavailable at the source. The foundational item’s unavailability may render items previously obtained by the picker unsuitable for the user’s purpose in creating the order, which may increase an amount of time spent by the picker fulfilling the order by replacing the previously obtained items.

As obtaining a foundational item in the order determines whether the user is satisfied or is unsatisfied with fulfillment of the order, the online system may perform one or more remedial actions in response to the foundational item being unavailable. Performing a remedial action mitigates unavailability of the foundational item to increase a likelihood of the user placing subsequent order with the online system. In an example remedial action, the online system offers the user a refund of a price of the foundational item in response to the picker being unable to obtain the foundational item. As another example of a remedial action, the online system suggests one or more replacement items for the foundational item in response to the foundational item being unavailable. The user may select one of the replacement items to replace the foundational item in the order. However, if the user selects a replacement item for the foundational item, one or more additional items in the order that depend on the foundational item may be unsuitable for use with the replacement item. So, replacing the foundational item with a replacement item may cause the user to replace additional items with corresponding replacement items, increasing an amount of time spent by the picker fulfilling the order.

Because a picker is unable to determine whether a foundational item is unavailable at a source until the picker is fulfilling the order, the picker and the user have limited time to select and to implement one or more remedial actions if the foundational item is unavailable while the picker is fulfilling the order. As the order does not include an indication as to which items are foundational, the picker may obtain multiple items in the order before determining that the foundational item is unavailable. Subsequently, if the user replaces an unavailable foundational item with a replacement item, the picker may expend significant time replacing previously obtained items with corresponding replacement items, as the items already obtained by the picker may not be compatible with or complementary to the replacement item for the foundational item. An increased amount of time spent by the picker fulfilling the order increases a cost to the online system of fulfilling the order for the user.

To fulfill the order more efficiently by accounting for one or more foundational items included in the order, the online system identifies one or more foundational items included in the order. In various embodiments, the online system applies a foundational item model to the order to identify one or more foundational items. The foundational item model generates a probability of each item of the order being a foundational item. In various embodiments, the online system identifies an item in the order as a foundational item in response to a probability of the item being a foundational item generated by the foundational item model equaling or exceeding a threshold value, In various embodiments, the foundational item model is trained through application to multiple training examples in a backpropagation process, with each training example including a group of items and a label indicating which items of the group are foundational items.

In some embodiments, the score for an item of the order is based on correlation scores between the item and other items in the order determined by the foundational item model. In various embodiments, the score for an item is a number of other items in the order having a correlation score to the item equaling or exceeding a threshold value. An additional item having a correlation score to the item equaling or exceeding a threshold value is identified as a dependent item from the item in various embodiments. Hence, items in the order having larger numbers of dependent items have higher positions in the sequence, as such items affect the user’s subsequent use of the dependent items. In some embodiments, the foundational item model generates correlation scores between each item in the order and each other item in the order and determines the score for each item in the order based on dependencies between items determined from the correlation scores. For example, the foundational item model identifies an item having at least a threshold correlation score with at least a threshold number of other items included in the order as a foundational item. Each item having at least a threshold correlation score with the foundational item is a dependent item from the foundational item. Based on the number of dependent items from a foundational item, the foundational item model generates a score for the foundational item.

In some embodiments, the online system applies the foundational item model to the order after receiving the order from the user and before the order is allocated to a picker for fulfillment. The online system stores indications in association with items determined to be foundational items. For example, the online system stores an indication that an item is foundational in association with an identifier of the order and an identifier of the item. Alternatively, the online system applies the foundational item model to the order when the order is allocated to a picker for fulfillment, and similarly stores an indication in association with items in the order determined to be foundational items. However, in other embodiments, the online system may apply the foundational item model to the order at another time relative to a picker beginning to obtain items for the order.

When the picker begins fulfilling the order, the online system provides information for fulfilling the order from the source to the picker via a picker client device. In various embodiments, information provided to the picker includes a sequence for obtaining items in the order from the source that maximizes efficiency with which the picker navigates the source. This reduces an amount of time for the picker to fulfill the order, which decreases a cost incurred by the online system from the picker’s time fulfilling the order. As availability of a foundational item in the order at the source affects whether the picker successfully fulfills the order, when determining the sequence of items in the order for the picker, the online system applies a sequencing model to the items included in the order and to the foundational item identified in the order. In some embodiments, the sequencing model determines the sequence of items of the order so one or more foundational items of the order each have at least a threshold position in the sequence to reduce a number of other items of the order the picker may obtain before determining whether a foundational item is available at the source.

In some embodiments, the online system applies the sequencing model to determine the sequence in response to receiving an order status from the picker that the picker has arrived at the source. Alternatively, the online system applies the sequencing model to determine the sequence after receiving the order and before the picker is allocated to fulfill the order. In another embodiment, the online system applies the sequencing model to determine the sequence after the picker is allocated to fulfill the order and before the picker arrives at the source.

The sequencing model may determine positions of items in the sequence based on their scores from the foundational item model. For example, a higher score for an item indicates the item is more likely to be a foundational item, so the sequencing model places the item in a higher position of the sequence Positioning items with higher scores in higher positions of the sequence prompts the picker to obtain items with higher scores before obtaining other items.

Information about an item received by the sequencing model includes one or more attributes of the item (e.g., an item category of the item, a dietary type of the item, etc.), an availability of the item at the source identified by the order, one or more replacement items for the item specified by the user, or other information about the item or related to the item. Information about the user from whom the order was received includes one or more dietary preferences, dietary restrictions, or other preferences for items. The sequencing model may receive different or additional information about one or more items of the order or about the user in various embodiments. For example, the sequencing model receives a layout of the source that identifies physical positions of different items within the source.

In some embodiments, the sequencing model determines the sequence of items for the order based on an expected cost to the online system for fulfilling the order based on a sequence. For example, the online system generates a set of candidate sequences for the order, with different candidate sequences having the foundational item of the order in different positions relative to other items. The sequencing model determines an expected cost to the online system of each candidate sequence and selects the candidate sequence with a minimum cost as the sequence. For example, the sequencing model determines an expected cost of a candidate sequence as a difference between cost to the online system for an amount of time the picker spends obtaining items when the foundational item has a highest position in the sequence and a product of a probability of the foundational item being unavailable and a cost to the online system for a picker restocking items having positions in the sequence higher than a position of the foundational item. In other embodiments, the sequencing model determines the expected cost of a candidate sequence using one or more alternative methods.

In response to determining the foundational item is unavailable at the source, the online system receives an order status from the picker via the picker client device identifying the foundational item, the order, and indicating the foundational item is unavailable at the source. In response to receiving the order status, the online system transmits a notification to the user client device of the user identifying the order and identifying the foundational item as unavailable. The notification includes one or more remedial actions for the user in various embodiments. For example, a remedial action is the online system refunding the user a cost of the foundational item, with the notification including an interface element that, when selected by the user, requests the refund of the cost of the foundational item.

As another example, the online system selects one or more recommended replacement items for the foundational item and identifies one or more of the recommended replacement items in the notification. In various embodiments, the recommended replacement items are based on attributes of the replacement items, attributes of the foundational item, and characteristics of the user (e.g., prior replacements of items by the user, etc.). The online system applies a trained replacement selection model to the foundational item, the other items in the order, and characteristics of the user in some embodiments to select recommended replacement items for the foundational item. Each recommended replacement item has a corresponding interface element in the notification that, when selected by the user, replaces the foundational item with the corresponding recommended replacement item. Having the foundational item in at least the threshold position in the sequence has the picker make an earlier determination whether the foundational item is unavailable at the source when fulfilling the order, allowing the online system to notify the user that the foundational item is unavailable when the picker is early on in fulfilling the order. This provides the user with additional time to select a remedial action to compensate for the unavailability of the foundational item while the picker is in the source fulfilling the order.

In some embodiments, the notification also identifies one or more dependent items from the foundational item and includes one or more interface elements proximate to each dependent item. For example, an interface element in the notification proximate to a dependent item, when selected by the user, removes the dependent item from the order. As another example, the notification includes an interface element for a replacement item for the dependent item that, when selected by the user, replaces the dependent item with the replacement item. The online system may determine dependent items from the foundational item based on correlation scores between items in the order and the foundational item determined by the sequencing model in some embodiments. Alternatively, the online system applies a generative model (e.g., a large language model) to a prompt including the foundational item and the items of the order with an instruction to identify items in the order dependent from the foundational item. The generative model determines dependent items from the foundational item based on the foundational item, the items in the order, and previously learned relationships.

Having the foundational item in a highest position, or at least the threshold position, in the sequence causes the user client device to receive the notification before the picker obtains a substantial number of items in the order. Further, the user may replace the foundational item and one or more dependent items from the foundational item with corresponding replacement items before the picker obtains the items originally included in the order through interaction with the notification. Transmitting the notification to the user client device while the picker is early in fulfilling the order decreases a likelihood of the picker from restocking previously obtained items and obtaining replacement items selected by the user for the restocked items.

Having the foundational item of the order in at least the threshold position of the sequence has the picker attempt to obtain the foundational item before obtaining other items of the order. In response to determining an item is unavailable at the source, the picker notifies the online system of the unavailability of the foundational item before obtaining other items of the order. The online system transmits the notification of the unavailability of the foundational item to the user client device of the user, allowing the user to determine whether to replace the foundational item with a replacement item and whether to replace one or more items in order that depend on the foundational item before the picker obtains the dependent items. This allows user modification of items included in the order based on the unavailability of the foundational item before the picker obtains other items in the order that may subsequently need to be restocked and replaced with corresponding replacement items based on a replacement item the user selected for the foundational item. Allowing a user to modify items in the order when the picker has selected fewer items reduces an amount of time spent by the picker fulfilling the order, decreasing a cost incurred by the online system from the amount of time spent by the picker fulfilling the order.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 illustrates a flowchart of a method for determining a sequence of items in an order based on a machine-learning model identifying a foundational item of the order, in accordance with one or more embodiments.

FIG. 4 illustrates a process flow diagram of a method for determining a sequence of items in an order based on a machine-learning model identifying a foundational item of the order, in accordance with one or more embodiments.

### DETAILED DESCRIPTION

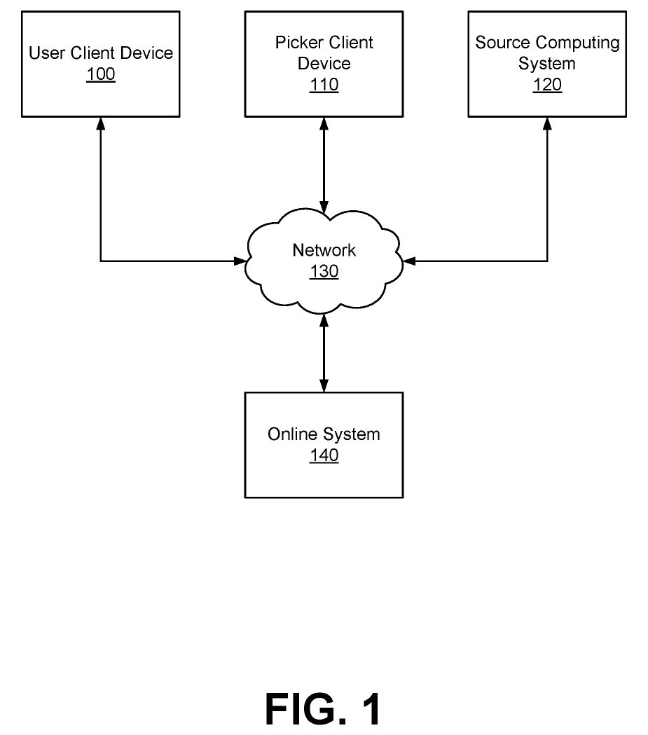

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user’s order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user’s order to the picker in a collection interface. The collection interface is a user interface that provides information to the picker on which items to collect for a user’s order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

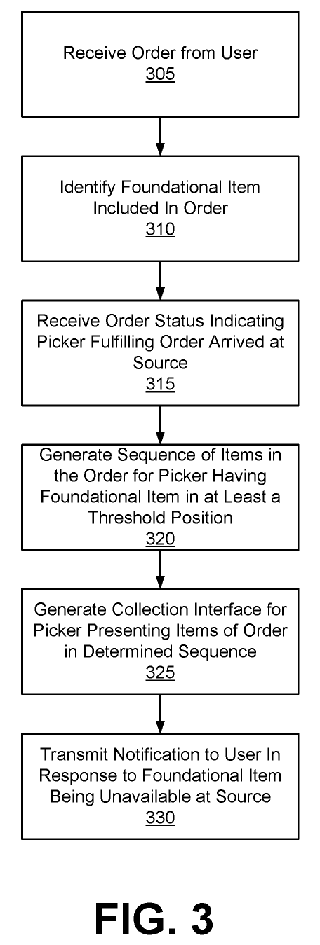

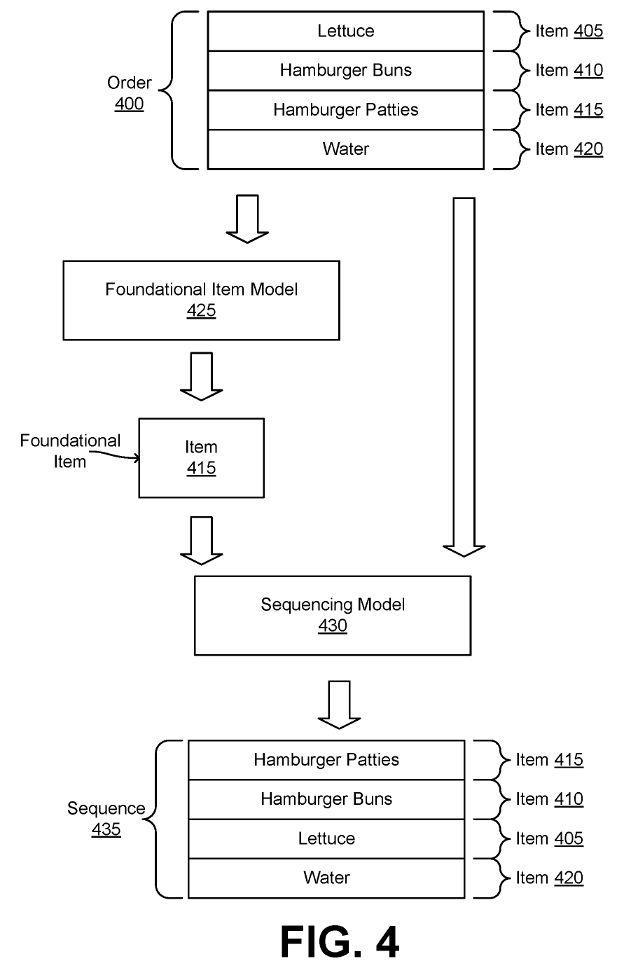

As further described below in conjunction with FIGS. 3 and 4, in various embodiments the collection interface displays items in an order in a sequence determined by the online system 140. The picker obtains items from the order based on positions in the sequence of the items, so the picker obtains items in higher positions of the sequence before obtaining items in lower positions of the sequence. As further described below in conjunction with FIGS. 3 and 4, the online system 140 determines positions of items in the sequence to minimize an amount of time spent by the picker in the source or to minimize a cost incurred to the online system 140 from the picker fulfilling the order. The order may include one or more foundational items, which are items that the picker cannot fail to obtain in the order to successfully fulfill the order. The online system 140 may implement one or more remedial actions for the user in response to the picker determining a foundational item is unavailable at the source. To provide the user with an increased amount of time to select a remedial action while the picker is fulfilling the order, the online system 140 identifies one or more foundational items in the order and determines the sequence of items in the order that accounts for whether one or more items of the order are foundational items, as further described below in conjunction with FIGS. 3 and 4.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user’s order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker’s location. For example, if the picker takes a wrong turn while traveling to a delivery location, the online system 140 determines the picker’s updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. Patent Application No. 18/630,672, entitled “Automated Identification of Items Placed in a Cart and Recommendations based on Same,” filed April 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user’s order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user’s order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

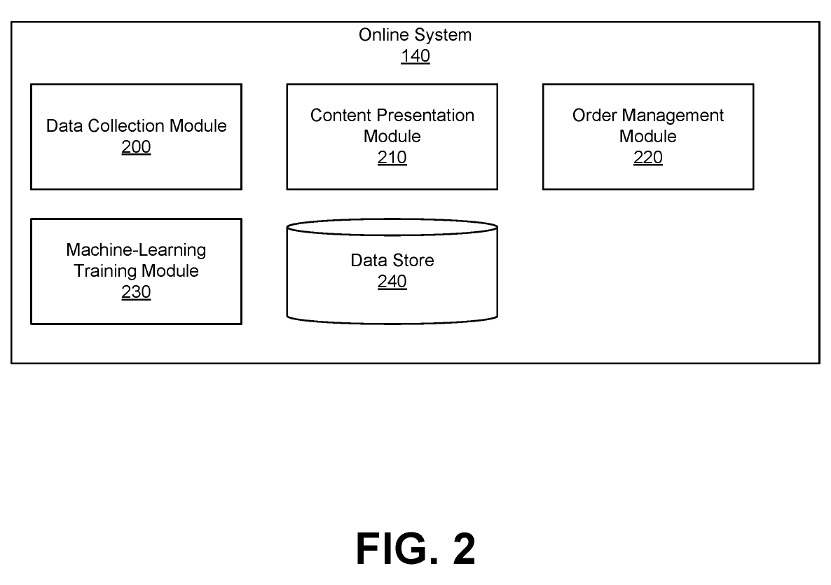

As an example, the online system 140 may allow a user to order groceries from a grocery store source. The user’s order may specify which groceries they want to be delivered from the grocery store and the quantities of each of the groceries. The user’s client device 100 transmits the user’s order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user’s name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user’s interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker’s name, the picker’s location, how often the picker has serviced orders for the online system 140, a user rating for the picker, which sources the picker has collected items at, or the picker’s previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker’s interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker’s performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker’s location and the location of the source from which the ordered items are to be collected. The order management module 220 may also offer an order to a picker based on how many items are in the order, a vehicle operated by the picker, the delivery location, the picker’s preferences on how far to travel to deliver an order, the picker’s ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker’s current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user’s order.

The order management module 220 generates a collection interface for a picker fulfilling an order that is transmitted to a picker client device 110 of the picker for presentation. In various embodiments, the order management module 220 determines a sequence of items in an order that specifies how the picker should collect the items in the order from the source to efficiently obtain the items in the source. Each item has a position in the sequence, with an item’s position in the sequence indicating when the picker should obtain the item relative to other items in the order.

One or more items in the order may be “foundational items.” A foundational item is an item that a picker cannot fail to obtain when fulfilling the order. The picker being unable to obtain a foundational item renders one or more other items in the order useless to the user from whom the order was received. As an order does not include information identifying a foundational item in an order, the picker fulfilling the order is unable to discern from the order itself which items, if any, are foundational items. If a foundational item is unavailable when an order is being fulfilled, the order management module 220 may perform one or more remedial actions for a user to mitigate unavailability of the foundational item. For example, the order management module 220 refunds the user a cost of the foundational item. As another example, the order management module 220 identifies one or more replacement items for the foundational item that the user may select for inclusion in the order in place of the foundational item.

The picker fulfilling an order is unable to ascertain whether a foundational item in the order is available at a source until the picker is fulfilling the order from the source. This limits an amount of time for a user to select a remedial action if the foundational item is unavailable and for the picker to implement a remedial action while fulfilling the order. To increase an amount of time for a user to select a remedial action and for a picker to implement the remedial action, the order management module 220 identifies one or more foundational items in an order, as further described below in conjunction with FIGS. 3 and 4. The order management module 220 determines a sequence for the order that accounts for one or more foundational items in the order when positioning items in the sequence. For example, the sequence decreases a number of items the picker obtains from a source before determining whether the foundational item is available at the source, as further described below in conjunction with FIGS. 3 and 4.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

Further, the machine-learning training module 230 trains a foundational item model 425 to generate a probability of one or more items being a foundational item. The machine-learning training module 230 applies the sequencing model to multiple training examples of the training dataset. When applied to a training example, the sequencing model generates a predicted score for each item of the training example based on the attributes of items in the grouping and characteristics of a user associated with the grouping. The machine-learning training module 230 determines a score for the foundational item model 425 based on a difference between a label applied to an item of the training example and a predicted score for the item of the training example (e.g., through application of a loss function to the label applied to the item of the training example and the predicted score for the item of the training example). The machine-learning training module 230 updates the set of parameters for the foundational item model 425 based on the score generated by the loss function until one or more criteria are satisfied. Training of the foundational item model 425 is further described in U.S. Patent Application No. 17/846,887, filed on June 22, 2022, which is hereby incorporated by reference in its entirety.

In various embodiments, the machine-learning training module 230 trains a sequencing model to determine a sequence of items in an order. For example, the sequencing model determines positions of items in a sequence based at least in part on scores of the items. The sequencing model may determine a sequence so items with higher scores have higher positions in the ranking. In other embodiments, the sequencing model determines an expected cost to the online system 140 of a picker fulfilling an order when obtaining items based on a sequence. For example, the sequencing model determines an expected cost of a candidate sequence by determining a by subtracting a cost to the online system 140 for the amount of time the picker spends obtaining items when the foundational item has a highest position in the candidate sequence from a product of a probability of the foundational item being unavailable and a cost to the online system 140 for a picker restocking items having positions in the candidate sequence higher than a position of the foundational item. The sequencing model may determine a sequence of items in an order based on attributes of an item, characteristics of a user from whom the order was received, as well as other information, such as a layout of items in the source.

In some embodiments, the machine learning training module 230 trains or obtains one or more generative models. A generative model, such as a large language model (LLM), receives an input including a prompt and generates output based on the received input. For example, a generative model is a large language model (LLMs) previously trained on a large text corpus to learn relationships between different portions of text, such as between different words. Based on the previously learned relationships, the LLM generates output text from text received as input based on a prompt received as input. For example, a generative model receives a prompt including one or more formatting instructions and text data as input and generates output text in a format specified by the one or more formatting instructions and based on the input text and previously learned relationships between various text.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

FIG. 3 is a flowchart of a method for determining a sequence of items in an order based on a machine-learning model identifying a foundational item of the order, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system without human intervention.

The online system 140 receives 305 an order from a user including one or more items and identifying a source from which the items are to be obtained. Additionally, the order includes a location to which items included in the order are to be delivered. In some embodiments, the order also includes a time interval for delivering the obtained items in the order to the location in the order. Additional or alternative information may be included in the order in various embodiments. In various embodiments, the online system 140 allocates the order to a picker, who obtains items in the order from the source identified by the order and delivers the obtained items to the location identified by the order.

The order may include one or more “foundational items.” A foundational item is an item in the order that a picker cannot fail to obtain when fulfilling the order. The picker being unable to obtain a foundational item renders one or more other items in the order useless to the user from whom the order was received 305. So, a foundational item is an item in the order whose ability to be obtained determines whether fulfillment of the order is successful or is unsuccessful. For example, an order includes hamburger patties, lettuce, hamburger buns, pickles, and cheese. In the preceding example order, hamburger patties are a foundational item for the order, as an inability to obtain hamburger patties renders obtaining other items in the order, such as the hamburger bun, as useless for a purpose of the user from whom the order was received. In the preceding example, a picker obtaining all the items in the order other than the hamburger patties results in the user being unsatisfied with fulfillment of the order, as one or more other items that were obtained (e.g., the hamburger buns) are not useful to the user from whom the order was received 305 without having the hamburger patties. While the order may include one or more foundational items, the order does not include information identifying which items are foundational items when received 305 from the user.

To improve order fulfillment by the picker fulfilling the order, in various embodiments, the online system 140 identifies 310 one or more foundational items in the order. For example, the online system 140 applies a trained foundational item model 425 to the order, and the foundational item model 425 outputs identifiers of one or more items that are foundational items in the order. An example of a foundational item model 425 is further described in U.S. Patent Application No. 17/846,887, filed on June 22, 2022, which is hereby incorporated by reference in its entirety. In various embodiments, the foundational item model 425 generates a score for each item representing a probability of each item in the order being a foundational item and identifies 310 an item in the order having at least a threshold score as a foundational item.

In various embodiments, the foundational item model 425 receives the items included in the order and characteristics of the user as input to determine a score for each item of the order. Additional data may be received as input in some embodiments. For example, the foundational item model 425 receives groupings of items that each include one or more items labeled as foundational items, which the foundational item model 425 leverages to identify 310 one or more items in the order as foundational items. The online system 140 stores an indication associated with the order that identifies each foundational item identified 310 in the order. For example, the online system 140 modifies the order to include a specific value associated with each item identified 310 as a foundational item. As another example, the online system 140 stores an identifier of each item identified 310 as a foundational item in association with an identifier of the order.

The foundational item model 425 comprises a set of weights stored on a non-transitory computer readable storage medium. The online system 140 trains the foundational item model 425 by generating a training dataset including multiple training examples. Each training example includes a grouping of items and a label applied to the grouping identifies one or more items of the grouping as foundational. A training example may further include attributes of each item in the grouping, characteristics of a user associated with the grouping of items, or other information. In various embodiments, the online system 140 generates training examples for the training dataset based on previously fulfilled orders from one or more users stored in the data store 240.

To train the foundational item model 425, the online concierge system 140 initializes the set of weights comprising the foundational item model 425 and applies the foundational item model 425 to multiple training examples of the training dataset. Applying the foundational item model 425 to multiple training examples updates one or more parameters (e.g., the weights) comprising the foundational item model 425. The parameters comprising the foundational item model 425 transform the input data (a grouping of items, attributes of each item in the grouping, and characteristics of a user associated with the grouping of items) into a score for each item of the grouping. When applied to a training example, the generates a predicted score for each item of the training example based on the attributes of items in the grouping and characteristics of a user associated with the grouping. The score of an item indicates a probability of the item being a foundational item in a grouping of items.

For each training example to which the foundational item model 425 is applied, the online concierge system 140 generates a score comprising an error term based on the predicted score for an item in the training example and a label applied to the item in the training example. The error term is larger when a difference between the predicted score for the item in the training example and the label applied to the item in the training example is larger and is smaller when the difference between the predicted score for the item in the training example and the label applied to the item in the training example is smaller. In various embodiments, the online concierge system 140 generates the error term using a loss function based on a difference between the predicted score for the item in the training example and the label applied to the item in the training example using a loss function. Example loss functions include a mean square error function, a mean absolute error, a hinge loss function, and a cross-entropy loss function.

The online concierge system 140 backpropagates the error term to update the set of parameters comprising the foundational item model 425 and stops backpropagation in response to the error term, or to the loss function, satisfying one or more criteria. For example, the online concierge system 140 backpropagates the error term through the foundational item model 425 to update parameters of the foundational item model 425 until the error term has less than a threshold value. For example, the online system 140 may apply gradient descent to update the set of parameters. The online system 140 stores the set of parameters comprising the foundational item model 425 on a non-transitory computer readable storage medium after stopping the backpropagation.

In various embodiments, the foundational item model 425 generates a correlation score for each pair of items included in the order as well as information about the user. The foundational item model 425 may generate a correlation score between an item of the order and a group of items included in the order (or between the item and different groups of items included in the order) in various embodiments. In the preceding example, each group includes two or more items included in the order. The foundational item model 425 determines an item having at least a threshold correlation score with multiple other items included in the order is a foundational item. For example, the foundational item model 425 determines an item of the order having at least the threshold correlation score to at least a threshold number of other items in the additional order is a foundational item. Each item having at least a threshold correlation score with the foundational item is a dependent item from the foundational item. Based on the dependent items for a foundational item, the foundational item model 425 generates a score for the foundational item. For example, the score for an item equals a number of dependent items from the foundational item.

In various embodiments, the online system 140 identifies 310 one or more foundational items in the order after receiving 305 the order from the user and before allocating the order to a picker. Alternatively, the online system 140 identifies 310 one or more foundational items in the order after allocating the order to a picker for fulfillment. In other embodiments, the online system 140 identifies 310 one or more foundational items in the order in response to receiving a specific order status from the picker fulfilling the order (e.g., in response to receiving an order status that the picker has arrived at a source identified by the order) or in response to another condition being satisfied.

To fulfill the order, the online system 140 allocates the order to a picker who obtains items in the order from a physical location of the source identified by the order, in various embodiments. Using a picker application executing on a picker client device 110, the picker provides various order statuses to the online system 140, providing the online system 140 with information about fulfillment of the order by the picker. For example, an order status identifies an action the picker completed or performed while fulfilling the order or provides other information describing order fulfillment by the picker. In an example, a picker transmits an order status that the picker has arrived at the physical location of the source to the online system 140 via a picker application executing on the picker client device 110. As another example, the picker transmits an order status comprising an indication that the picker has obtained an item in the order to the online system 140 via the picker application. In another example, the picker transmits a replacement notification as an order status to indicate the picker replaced an item included in the order with a replacement item.

An order status the online system 140 receives from the picker may indicate when the picker is performing certain actions. One example action is the picker arriving at the physical location of the source. Another example action is the picker entering a checkout line at the physical location of the retailer, while another example action is the picker leaving the physical location of the retailer. Different or additional actions may also be identified to the online system 140 via corresponding order statuses from the picker. An order status may be received after the picker performed an action, when the picker begins performing an action, or at another time relative to the picker performing an action in various embodiments. The online concierge system 140 stores an order status for the order in association with the order to indicate actions performed by the picker when fulfilling the order.

In some embodiments, the online system 140 receives 315 an order status that the picker arrived at the physical location of the source identified by the order when the picker arrives at the physical location of the source. The online system 140 stores the order status that the picker arrived at the physical location of the source in association with an identifier of the order. In various embodiments, the online system 140 generates 320 a sequence of the items in the order for the picker in response to receiving 315 the order status that the picker arrived at the physical location of the source included in the order. Alternatively, the online system 140 generates 320 the sequence of the items in the order after receiving 305 the order, but before allocating the order to a picker. In other embodiments, the online system 140 generates 320 the sequence of the items in the order after allocating the order to the picker, but before the picker arrives at the physical location of the source. The sequence of items identifies how the picker should obtain items relative to each other from the source to obtain the items more efficiently. Higher positions in the order indicate items in the order that the picker should obtain sooner when fulfilling the order, so positioning of items in the sequence affects when the picker obtains different items when fulfilling the order. In various embodiments, the highest position in the sequence identifies an item the user should obtain from the source first.

As further described above, the order itself does not include information identifying which items are foundational items. Additionally, the picker fulfilling the order is unable to determine whether a foundational item in the order is available at a source until the picker begins fulfilling the order. Without knowing which item, or items, in the order are foundational, the picker may obtain multiple other items in the order before determining the foundational item of the order is unavailable at the source. Unavailability of the foundational item may render items previously obtained by the picker unsuitable for the user’s purpose in creating the order, which may expend the picker’s time in replacing the previously obtained items depending on how the user elects to proceed if the foundational item is unavailable.

Because obtaining the one or more foundational items in the order determines whether the user is satisfied or is unsatisfied with fulfillment of the order, the online system may perform one or more remedial actions in response to the foundational item being unavailable. In an example remedial action, the online system 140 offers the user a refund of a price of the foundational item in response to the picker being unable to obtain the foundational item from the source. As another example remedial action, the online system 140 suggests one or more replacement items for the foundational item in response to the foundational item being unavailable. However, one or more additional items in the order 400 that depend on the foundational item may be unsuitable for use with a replacement item selected for the foundational item. Hence, replacing the foundational item with a replacement item may cause the user to replace additional items with corresponding replacement items. If the picker obtained multiple items before determining the foundational item was unavailable, the picker may expend additional time returning and replacing the previously obtained items with replacement items, increasing an amount of time to fulfill the order and a cost to the online system 140 from the picker’s time.

As obtaining the identified foundational item affects whether the picker successfully fulfills the order and a picker is unable to determine whether a foundational item is unavailable at a source until the picker is fulfilling the order, the picker and the user have limited time to implement remedial actions while the picker is fulfilling the order. To increase an amount of time for the user to select a remedial action or other course of action when a foundational item of the order is unavailable, the online system 140 accounts for whether an item is a foundational item when generating 320 the sequence of items. For example, the online system 140 accounts for scores for each item in the order when generating 320 the sequence of items. In various embodiments, a foundational item has at least a threshold position in the sequence, so the picker determines whether the foundational item is available soon after beginning to fulfill the order. Further, having the foundational item in at least the threshold position in the sequence reduces a number of items that the picker may obtain before determining whether the foundational item is available at the source. For example, the sequence includes the foundational item in a highest position.

In some embodiments, the online system 140 applies one or more rules for positioning items in the sequence to the items included in the order to generating 320 the sequence based at least in part on scores of one or more items of the order. For example, a rule specifies a position in the sequence of an item identified 310 as a foundational item. For example, a rule specifies an item identified 310 as the foundational item of the order has a highest position in the sequence. As another example, a rule specifies an item identified as the foundational item of the order has at least a threshold position in the sequence. One or more other rules based on attributes of various items in the order determine a position of the foundational item in the sequence that is not lower than the threshold position.

One or more rules may account for attributes of items, in addition to whether an item is the foundational item, to generate 320 the sequence. For example, an item has an attribute indicating the item is frozen, refrigerated, or has other special handling instructions. One or more rules position items having certain special handling instructions in lower positions of the sequence to decrease an amount of time the items are in conditions different than those encountered in the source. For example, items with attributes indicating they are frozen are positioned in lower positions in the ranking to minimize an amount of time that the items are not frozen. However, in response to the foundational item having an attribute indicating the foundational item is frozen or has other special handling instructions, a rule applied to the order generates a 320 a sequence that initially directs the picker to check if the foundational item is available at the source without obtaining the foundational item, then has other items in the order in positions of the sequence higher than a position of the foundational item. Such a sequence has the picker initially determine if the foundational item is available at the source before obtaining additional items in the order, then obtain one or more additional items in the order before obtaining the foundational item, so the picker determines whether the foundational item is available when beginning to fulfill the order but does not obtain the foundational item until later when fulfilling the order to be consistent with one or more special handling instructions for the foundational item.

Alternatively, the online system 140 generates 320 the sequence of items by applying a sequencing model to the order. In some embodiments, the sequencing model determines positions of items in the sequence based on the scores for the items. Items with higher scores have higher positions in the sequence. In various embodiments, the sequencing model receives an initial sequence of the items in the order and information about each item included in the order, including a score for one or more items in the order. The initial sequence of the items may be the items positioned based on times when the user included items in the order, so items the user first included in the order have higher positions in the initial sequence. Information about an item includes one or more attributes of the item (e.g., an item category of the item, a dietary type of the item, etc.), an availability of the item at the source identified by the order (e.g., a predicted availability of the item at the source, an availability of the item at the source received from a picker client device 110 or from a source computing system 120, etc.) , one or more replacement items for the item specified by the user, or other information about the item or related to the item. Information about the user from whom the order was received includes one or more dietary preferences, dietary restrictions, or other preferences for items. The sequencing model may receive information about the source in some embodiments, such as a layout of items within the source identifying relative positioning of items in the source to each other. In some embodiments, the online system 140 determines 320 the sequence of items in the order in response to identifying 310 at least one foundational item but does not determine 320 the sequence of items in the order in response to not identifying 310 at least one foundational item of the order through application of the foundational item model 425. Alternatively, the sequencing model determines 320 the sequence of items regardless of whether the online system 140 identifies 310 at least one foundational item in the order.

In various embodiments, the sequencing model determines 320 the sequence based on attributes of the items in the order, characteristics of the user, and an expected cost to the online system 140 for a picker obtaining items based on the sequence. The online system 140 incurs a cost based on an amount of time spent by a picker fulfilling the order, and a position of the foundational item in the sequence may increase or decrease an amount of time spent by the picker fulfilling the order. To account for an amount of time spent by the picker fulfilling the order when generating 320 the sequence, the sequencing model determines an expected cost to the online system 140 for fulfilling the order based on a sequence. For example, the online system 140 generates a set of candidate sequences for the order. Different candidate sequences have the foundational item of the order in a different position relative to one or more other items of the order. The sequencing model determines an expected cost to the online system 140 of each candidate sequence and selects a candidate sequence based on their corresponding expected costs. For example, the sequencing model determines an expected cost of a candidate sequence by determining a by subtracting a cost to the online system 140 for the amount of time the picker spends obtaining items when the foundational item has a highest position in the candidate sequence from a product of a probability of the foundational item being unavailable and a cost to the online system 140 for a picker restocking items having positions in the candidate sequence higher than a position of the foundational item. In various embodiments, the sequencing model determines 320 the sequence as a candidate sequence with a minimum expected cost to the online system 140, which indicates a minimum amount of time spent fulfilling the order by the picker. The online system 140 uses an availability model, as further described above in conjunction with FIG. 2, to determine the probability of the foundational item being unavailable in various embodiments.

In some embodiments, the online system 140 applies one or more rules to the sequence that modify the sequence based on attributes of one or more items. For example, in response to the foundational item having an attribute indicating special handling by the picker (e.g., the foundational item is frozen or refrigerated), the online system 140 applies one or more rules to the sequence so the sequence initially identifies the foundational item with an instruction to check for availability in a threshold position and also includes the foundational item at a lower position with an instruction to obtain the foundational item. This determines 320 a sequence where the picker determines whether the foundational item is available when beginning to fulfill the order but does not obtain the foundational item until later in order fulfillment to be consistent with the special handling attribute of the foundational item.

Based on the sequence of items determined 320 for the order, the online system 140 generates 325 a collection interface for the picker. As further described above in conjunction with FIG. 1, the collection interface is a user interface presented by a picker client device 110 to provide the picker with information on items to obtain for the order and the quantities of the items to obtain. The collection interface presents instructions that the user may have included related to the collection of items in the order in some embodiments. The collection interface identifies the items of the order to the picker in the determined sequence and identifies a location of each item of the order at the source. Presenting the items of the order to the picker in the determined sequence allows the picker to fulfill the order more efficiently and to more rapidly identify whether the foundational item included in the order is available at the source.

The online system 140 transmits the collection interface to the picker client device 110 of the picker, which displays the collection interface to the picker. The positions of items of the order in the determined sequence provide the picker with a route through the source to obtain items relative to each other. As the determined sequence has the foundational item (or one or more foundational items) of the order at least a threshold position, the collection interface directs the picker to obtain the foundational items before obtaining one or more other items, such as dependent items from a foundational item. This causes the picker to determine whether a foundational item is available at the source when the picker begins fulfilling the order, decreasing a number of items of the order the picker obtains before determining whether the foundational item is available.

In response to the picker determining the foundational item is not available at the source, the picker transmits an order status from the picker client device 110 to the online system 140 indicating the foundational item is not available at the source. In response to receiving the order status that the foundational item is unavailable at the source, the online system 140 transmits 330 a notification to the user client device 100 of the user indicating the foundational item is unavailable at the source. In various embodiments, the online system 140 generates the notification and includes one or more recommendations in the notification to provide the user with additional information for addressing the unavailability of the foundational item at the source.

For example, the notification identifies the foundational item that is unavailable and includes one or more recommended replacement items for the functional item. The user may select a recommended replacement item via the notification to replace the foundational with the selected recommended replacement item. In various embodiments, the online system 140 selects one or more recommended replacement items as items one or more other users selected to replace the foundational item. Further, the online system 140 may account for other attributes of items when identifying selected recommended replacement items. For example, the online system 140 accounts for differences between a price of the foundational item that was unavailable and prices of candidate replacement items. The online system 140 may select recommended replacement items having prices with larger differences from the price of the foundational item that was unavailable as recommended replacement items in some embodiments or may select recommended replacement items having prices with smaller differences from the price of the foundational item that was unavailable as recommended replacement items in other embodiments.

In some embodiments, the online system 140 accounts for compensation received from the source or from an entity associated with one or more recommended replacement items when selecting recommended replacement items, increasing a likelihood of identifying a recommended replacement items in response to receiving a greater amount of compensation from the source or from an entity associated with a recommended replacement item. Alternatively or additionally, the online system 140 applies a replacement selection model to attributes of the foundational item, characteristics of the user, and attributes of other items to select one or more recommended replacement items. The replacement selection model may account for prior selection of replacement items by the user, as well as amounts of compensation the online system 140 receives from the source or from another entity in response to the user selecting various replacement items for inclusion in the order. For example, the replacement selection model ranks replacement items based on a combination of compensation received by the online system 140 and a likelihood of a user performing a specific interaction with different replacement items (e.g., including replacement items in an order) and selects one or more replacement items having at least a threshold position in the ranking for presentation.

Additionally, the notification may identify one or more dependent items from the foundational item and other items in the order affected by the unavailability of the foundational item to the user. For example, the notification includes one or more interface elements presented proximate to each dependent item allowing the user to remove a dependent item from the order or to replace the dependent item with a replacement item. In some embodiments, the online system 140 leverages the sequencing model to identify dependent items from the foundational item. For example, the online system 140 identifies items having at least a threshold correlation score with the foundational item determined by the sequencing model as dependent items in the notification.

In some embodiments, the online system 140 determines one or more suggested replacement items for a dependent item in response to receiving a selection of a replacement item for the foundational item from the user. A suggested replacement item for a dependent item is based at least in part on the replacement item selected for the foundational item, allowing the user to easily modify items included in the order based on the replacement item for the foundational item. In some embodiments, the online system 140 selects one or more suggested replacement items for a dependent item by identifying one or more recipes or other collections of items including the replacement item selected for the foundational item and determining suggested replacement items for one or more dependent items based on items included in recipes including the replacement item selected for the foundational item.

Alternatively or additionally, the online system 140 generates a prompt for a generative model (e.g., a large language model) including the foundational item unavailable at the source, the items included in the order, and an instruction to identify additional items in the order dependent from the foundational item. Based on relationships between portions of text learned during pre-training, the generative model determines dependent items in the order from the foundational item. For each dependent item, the online system 140 selects one or more replacement items based on a replacement item selected for the foundational item, as further described above. This proactively identifies dependent items affected by unavailability of the foundational item, and simplifies replacement of one or more dependent items along with replacement of the foundational item unavailable at the source. Including dependent items in a notification that the foundational item is unavailable at the source allows the user more time to evaluate whether to replace one or more dependent items from the foundational item and to select replacements for dependent items affected by unavailability of the foundational item.

Presenting items of the order to the picker based on the determined sequence reduces a number of items from the order the picker may obtain before determining a foundational item of the order is unavailable at the source. This reduces an amount of time the picker may spend restocking previously obtained items if the foundational item is unavailable. Additionally, determining the foundational item earlier during fulfillment of the order by the picker increases an amount of time the user has to respond to a notification that the foundational item is unavailable, simplifying modification of the order to compensate for the unavailability of the foundational item while the picker is in the source.

FIG. 4 is a process flow diagram of a method for determining a sequence of items in an order based on a machine-learning model identifying a foundational item of the order. An online system 140 receives an order 400 from a user including one or more items and identifying a source from which the one or more items are obtained. Further, the order 400 includes a location for delivering the one or more items in the order and may include a time interval for delivering the one or more items to the location. For purposes of illustration, FIG. 4 shows an example order 400 including four items – item 405 of “lettuce,” item 410 of “hamburger buns,” item 415 of “hamburger patties,” and item 420 of “water.” In various embodiments, the order initially sequences items in the order based on a time when the user selected the items for inclusion in the order. Hence, in the example of FIG. 4, the user selected item 405 for inclusion in the order 400 first and selected item 420 for inclusion in the order last.

As further described above in conjunction with FIG. 3, the order 400 may include one or more “foundational items.” A foundational item is an item in the order 400 that a picker fulfilling the order 400 cannot fail to obtain when fulfilling the order 400. Inability to obtain a foundational item renders one or more other items in the order 400 useless to the user from whom the order 400 was received. Hence, a foundational item is an item in the order 400 whose ability to be obtained determines whether fulfillment of the order 400 is successful or is not successful to the user. In the example, of FIG. 4, a picker obtaining all the items in the order 400 other than the hamburger patties (item 415) would result in the user being unsatisfied with fulfillment of the order 400, as one or more other items depend on the foundational item for a purpose of the user for the order 400, so one or more other items in the order 400 are useless to the user without the foundational item. The order 400 may include multiple foundational items in various embodiments, with different foundational items affecting different groups of items in the order 400.

However, the order 400 does not include information identifying which items are foundational items. Additionally, the picker fulfilling the order 400 is unable to determine whether a foundational item in the order 400 is available at a source until the picker begins fulfilling the order 400. So, a picker may obtain multiple other items in the order 400 before determining the foundational item of the order 400 is unavailable at the source. The foundational item’s unavailability may render items previously obtained by the picker unsuitable for the user’s purpose in creating the order 400, which may increase an amount of time spent by the picker in the source replacing the previously obtained items.

As obtaining a foundational item in the order 400 determines whether the user is satisfied or is unsatisfied with fulfillment of the order 400, the online system 140 may perform one or more remedial actions in response to the foundational item being unavailable. In an example remedial action, the online system 140 offers the user a refund of a price of the foundational item in response to the picker being unable to obtain the foundational item. As another example remedial action, the online system 140 suggests one or more replacement items for the foundational item in response to the foundational item being unavailable. However, if the user selects a replacement item for the foundational item, one or more additional items in the order 400 that depend on the foundational item may be unsuitable for use with the replacement item. So, replacing the foundational item with a replacement item may cause the user to replace additional items with corresponding replacement items, increasing an amount of time spent by the picker fulfilling the order 400.

Because a picker is unable to determine whether a foundational item is unavailable at a source until the picker is fulfilling the order, the picker and the user have limited time to select and to implement one or more remedial actions if the foundational item is unavailable while the picker is fulfilling the order 400. As the order 400 does not include an indication as to which items are foundational, the picker may obtain multiple items in the order 400 before determining that the foundational item is unavailable. In the preceding example, the picker may expend significant time replacing previously obtained items with corresponding replacement items if the user replaces the unavailable foundational item with a replacement item, as the items already obtained by the picker may not be compatible with or complementary to the replacement item for the foundational item. If the picker obtained multiple items before determining the foundational item was unavailable, the picker may further spend additional time returning and replacing the previously obtained items with corresponding replacement items. An increased amount of time spent by the picker fulfilling the order 400 increases a cost to the online system 140 of fulfilling the order 400 for the user.

To fulfill the order more efficiently 400 by accounting for one or more foundational items included in the order 400, the online system 140 applies a foundational item model 425 to the order 400 in various embodiments. As further described above in conjunction with FIG. 3, the foundational item model 425 generates a score for each of item 405, item 410, item 415, and item 420 being a foundational item. The score for an item indicates a probability of an item being a foundational item for the order 400. In various embodiments, the online system 140 identifies an item in the order 400 a foundational item in response to a probability of the item being a foundational item generated by the foundational item model 425 equaling or exceeding a threshold value. For purposes of illustration, FIG. 4 shows an example where item 415 is determined to be a foundational item for the order 400 (e.g., the score for item 415 equals or exceeds the threshold value). While FIG. 4 shows an example where the order 400 includes a single foundational item, item 415, the order 400 may include multiple foundational items in other embodiments. Further, some orders may not include a foundational item.

As further described above in conjunction with FIG. 3, in some embodiments, the score for an item of the order 400 is based on correlation scores between the item and other items in the order determined by the foundational item model 425. In various embodiments, the score for an item is a number of other items in the order 400 having a correlation score to the item equaling or exceeding a threshold value. An additional item having a correlation score to the item equaling or exceeding a threshold value is identified as a dependent item from the item in various embodiments. Hence, items in the order having larger numbers of dependent items have higher positions in the sequence 435, as such items affect the user’s subsequent use of the dependent items. In some embodiments, the foundational item model 425 generates correlation scores between each item in the order 400 and each other item in the order and determines the score for each item in the order 400 based on dependencies between items determined from the correlation scores. For example, the foundational item model 425 identifies an item having at least a threshold correlation score with at least a threshold number of other items included in the order 400 as a foundational item. Each item having at least a threshold correlation score with the foundational item is a dependent item from the foundational item. Based on the number of dependent items from a foundational item, the foundational item model 425 generates a score for the foundational item.

In some embodiments, the online system 140 applies the foundational item model 425 to the order 400 after receiving the order 400 from the user and before the order 400 is allocated to a picker for fulfillment. The online system 140 stores indications in association with items determined to be foundational items. For example, the online system 140 stores an indication that item 415 is foundational in association with an identifier of the order 400 and an identifier of item 415. Alternatively, the online system 140 applies the foundational item model 425 to the order when the order 400 is allocated to a picker for fulfillment, and similarly stores an indication in association with items in the order determined to be foundational items, such as item 415 in the example of FIG. 4. However, in other embodiments, the online system 140 may apply the foundational item model 425 to the order 400 at another time relative to a picker beginning to obtain items for the order 400.

When the picker begins fulfilling the order 400, the online system 140 provides information for fulfilling the order from 400 from the source to the picker via a picker client device 110. In various embodiments, information provided to the picker includes a sequence 435 for obtaining items in the order 400 from the source that maximizes efficiency with which the picker navigates the source. This reduces an amount of time for the picker to fulfill the order 400, which decreases a cost incurred by the online system 140 from the picker’s time fulfilling the order 400. As availability of a foundational item in the order 400 at the source affects whether the picker successfully fulfills the order, when determining the sequence of items in the order for the picker, the online system 140 applies a sequencing model 430 to the items included in the order 400 and to the foundational item identified in the order, item 415 in FIG. 4. The sequencing model 430 determines the sequence of items of the order 400 so one or more foundational items of the order each have at least a threshold position in the sequence to reduce a number of other items of the order the picker may obtain before determining whether a foundational item is available at the source.

As further described above in conjunction with FIG. 3, in various embodiments the sequencing model 430 determines a position in the sequence 435 for each item based on its corresponding score. A higher score for an item indicates the item is more likely to be a foundational item, so the sequencing model 430 places the item in a higher position of the sequence 435 This positioning of items with higher scores in higher positions of the sequence prompts the picker to obtain items with higher scores before obtaining other items.

Information about an item received by the sequencing model 430 includes one or more attributes of the item (e.g., an item category of the item, a dietary type of the item, etc.), an availability of the item at the source identified by the order 400, one or more replacement items for the item specified by the user, or other information about the item or related to the item. Information about the user from whom the order was received includes one or more dietary preferences, dietary restrictions, or other preferences for items. The sequencing model 430 may receive different or additional information about one or more items of the order 400 or about the user in various embodiments. For example, the sequencing model 430 receives a layout of the source that identifies physical positions of different items within the source.

As further described above in conjunction with FIG. 3, in various embodiments, the sequencing model 430 determines positions of items in the sequence 435 based on an expected cost to the online system 140 for fulfilling an item using the sequence 435. For example, the online system 140 generates a set of candidate sequences for the order 400, with different candidate sequences having the foundational item of the order 400 in different positions relative to other items. The sequencing model 430 determines an expected cost to the online system 140 of each candidate sequence and selects the candidate sequence with a minimum cost as the sequence 435. For example, the sequencing model 430 determines an expected cost of a candidate sequence as a difference between cost to the online system 140 for an amount of time the picker spends obtaining items when the foundational item has a highest position in the sequence and a product of a probability of the foundational item being unavailable and a cost to the online system 140 for a picker restocking items having positions in the sequence higher than a position of the foundational item. In other embodiments, the sequencing model 430 determines the expected cost of a candidate sequence using one or more alternative methods.

In the example of FIG. 4, the sequencing model 430 determines a sequence 435 for the order 400 having item 415, “hamburger patties,” in a highest position, having item 410, “hamburger buns,” in a second highest position, having item 420, “lettuce,” in a third highest position, and having item 420, “water,” in a lowest position. As item 415 was identified as the foundational item of order 400 in the example of FIG. 4, the example sequence 435 has the foundational item, item 415, in a highest position. Having the foundational item in the highest position of the sequence 435 causes the picker to determine whether the foundational item of the order 400 is available at the source before obtaining other items in the order 400. Determining whether the foundational item is available when the picker starts fulfilling the order increases an amount of time for the picker and the user to determine how to proceed with fulfilling the order 400 if the foundational item is unavailable.

In response to determining the foundational item is unavailable at the source, the online system 140 receives an order status from the picker via the picker client device 110 identifying the foundational item, the order 400, and indicating the foundational item is unavailable at the source. In response to receiving the order status, the online system 140 transmits a notification to the user client device 100 of the user identifying the order and identifying the foundational item as unavailable. As further described above in conjunction with FIG. 3, the notification includes one or more remedial actions for the user in various embodiments. For example, a remedial action is the online system 140 refunding the user a cost of the foundational item, with the notification including an interface element that, when selected by the user, requests the refund of the cost of the foundational item.

As another example, the online system 140 selects one or more recommended replacement items for the foundational item and identifies one or more of the recommended replacement items in the notification, as further described above in conjunction with FIG. 3. In various embodiments, the recommended replacement items are based on attributes of the replacement items, attributes of the foundational item, and characteristics of the user (e.g., prior replacements of items by the user, etc.). The online system 140 applies a trained replacement selection model to the item, the other items in the order, and characteristics of the user in some embodiments to select recommended replacement items for the foundational item. Each recommended replacement item has a corresponding interface element in the notification that, when selected by the user, replaces the foundational item with the corresponding recommended replacement item. Having the foundational item in at least the threshold position in the sequence 435 has the picker make an earlier determination whether the foundational item is unavailable at the source, allowing the online system 140 to notify the user that the foundational item is unavailable when the picker is early on in fulfilling the order. This provides the user with additional time to select a remedial action to compensate for the unavailability of the foundational item while the picker is in the source fulfilling the order 400.

In some embodiments, the notification also identifies one or more dependent items from the foundational item determined to be unavailable and includes one or more interface elements proximate to each dependent item. For example, an interface element in the notification proximate to a dependent item, when selected by the user, removes the dependent item from the order 400. As another example, the notification includes an interface element for a replacement item for the dependent item that, when selected by the user, replaces the dependent item with the replacement item. As further described above in conjunction with FIG. 3, the online system 140 determines dependent items from the foundational item based on correlation scores between items in the order 400 and the foundational item determined by the sequencing model in some embodiments. Alternatively, as further described above in conjunction with FIG. 3, the online system 140 applies a generative model (e.g., a large language model) to a prompt including the foundational item and the items of the order 400 with an instruction to identify items in the order dependent from the foundational item. The generative model determines dependent items from the foundational item based on the foundational item, the items in the order, and previously learned relationships. Having the foundational item in a highest position, or at least the threshold position, in the sequence 435 causes the user client device 100 to receive the notification before the picker obtains a substantial number of items in the order 400. Further, the user may replace the foundational item and one or more dependent items from the foundational item with corresponding replacement items before the picker obtains the items originally included in the order 400 through interaction with the notification, preventing the picker from restocking previously obtained items and obtaining replacement items selected by the user for the restocked items.

In the example of FIG. 4, having item 415, the foundational item of the order 400, in a highest position of the sequence 435 has the picker attempt to obtain item 415 before obtaining other items of the order 400. In response to determining item 415 is not available at the source, the picker notifies the online system 140 of the unavailability of item 415 before obtaining item 405, item 410, or item 420. The online system 140 transmits the notification of the unavailability of item 415 to the user client device 100 of the user, allowing the user to determine whether to replace item 415 with a replacement item and whether to replace one or more items in order 400 depending on item 415 before the picker obtains item 405, item 410, or item 420. This allows user modification of items included in the order 400 based on the unavailability of item 415, the foundational item, before the picker obtains other items in the order 400 that may subsequently need to be restocked and replaced with corresponding replacement items based on a replacement item the user selected for the foundational item. Allowing a user to modify items in the order 400 when the picker has selected fewer items reduces an amount of time spent by the picker fulfilling the order 400, which decreases a cost incurred by the online system 140 from the amount of time spent by the picker fulfilling the order 400.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving, at the computer system, an order from a user, the order including one or more items to obtain from a source specified by the order;
generating scores for items included in the order by applying a foundational item model to the order and attributes of the items included in the order, wherein the foundational item model comprises a machine-learning model and is trained by:
retrieving training data including a plurality of training examples, each training example including: a grouping of items and attributes of items included in the grouping, and a label indicating which items of the grouping are foundational items;
applying the foundational item model to each training example of the training data to generate a predicted score for an item in the training example;
evaluating a loss function that compares the label of the training example to the predicted score; and
updating one or more parameters of the foundational item model based on the evaluated loss function;
identifying a foundational item from the one or more items included in the order based on the generated scores from the foundational item model;
generating, by the computer system, a sequence of the items in the order based on the identified foundational item, each item in the order having a corresponding position in the sequence; and
generating a collection interface for presentation by a user client device to the user, the collection interface presenting the one or more items in the determined sequence to provide an ordered sequence for obtaining the items from the source.

2. The method of claim 1, wherein generating the sequence of the items in the order based on the foundational item comprises:
receiving, at the computer system, an order status from the user client device that the user device is located at the source; and
generating, by the computer system, the sequence of the items in the order in response to receiving the order status that the user has arrived at the source.

3. The method of claim 1, wherein generating the sequence of the items in the order based on the foundational item comprises:
generating a sequence having the foundational item in at least a threshold position of the sequence.

4. The method of claim 1, further comprising:
transmitting a notification that the foundational item is unavailable at the source from the computer system to a user client device of the user in response to the computer system receiving an order status from the user client device that the foundational item is unavailable at the source.

5. The method of claim 4, wherein a score for an item is based on a number of other items in the order having at least a threshold correlation score to the item, a correlation score for an item determined by the foundational item model.

6. The method of claim 5, wherein transmitting the notification that the foundational item is unavailable at the source from the computer system to a user client device of the user in response to the computer system receiving the order status from the user client device that the foundational item is unavailable at the source comprises:
transmitting a notification identifying the foundational item and one or more additional items of the order that each have at least the threshold correlation score to the foundational item.

7. The method of claim 6, wherein the notification identifies a replacement item for at least one of the additional items of the order having at least the threshold correlation score to the foundational item.

8. The method of claim 1, wherein items of the order having higher scores have higher positions in the sequence.

9. The method of claim 1, wherein applying the foundational item model to the order and attributes of the items included in the order comprises applying the foundational item model to one or more of: one or more attributes of the item, an availability of the item at the source, or one or more replacement items for the item specified by the user.

10. The method of claim 1, wherein generating the sequence of the items in the order based on the foundational item comprises:
generating a set of candidate sequences, each candidate sequence including the foundational item in a different position;
generating an expected cost for each candidate sequence, the expected cost based at least in part on a probability of the foundational item being unavailable at the source; and
selecting the sequence as a candidate sequence having a minimum expected cost.

11. The method of claim 10, wherein generating an expected cost for a candidate sequence comprises subtracting a cost to the computer system for an amount of time the user spends obtaining items when the foundational item has a highest position in the sequence from a product of the probability of the foundational item being unavailable and a cost to the computer system for a user restocking items having positions in the candidate sequence higher than a position of the foundational item in the candidate sequence.

12. A computer program product comprising a non-transitory computer readable storage medium having instructions encoded thereon that, when executed by a processor, cause the processor to perform steps comprising:
receiving, at a computer system, an order from a user, the order including one or more items to obtain from a source specified by the order;
identifying a foundational item from the one or more items included in the order based on scores determined for items included in the order by applying a foundational item model to the order and attributes of the items included in the order, wherein the foundational item model comprises a machine-learning model and is trained by:
retrieving training data including a plurality of training examples, each training example including: a grouping of items and attributes of items included in the grouping, and a label indicating which items of the grouping are foundational items;
applying the foundational item model to each training example of the training data to generate a predicted score for an item in the training example;
evaluating a loss function that compares the label of the training example to the predicted score; and
updating one or more parameters of the foundational item model based on the evaluated loss function;
generating, by the computer system, a sequence of the items in the order based on the identified foundational item, each item in the order having a corresponding position in the sequence; and
generating a collection interface for presentation by a user client device to the user, the collection interface presenting the one or more items in the determined sequence indicating how a user should obtain the items from the source.

13. The computer program product of claim 12, wherein generating the sequence of the items in the order based on the foundational item comprises:
receiving, at the computer system, an order status from the user client device that the user device is located at the source; and
generating, by the computer system, the sequence of the items in the order in response to receiving the order status that the user has arrived at the source.

14. The computer program product of claim 12, wherein generating the sequence of the items in the order based on the foundational item comprises:
generating a sequence having the foundational item in at least a threshold position of the sequence.

15. The computer program product of claim 12, wherein the non-transitory computer readable storage medium further has instructions encoded thereon that, when executed by the processor, cause the processor to perform steps comprising:
transmitting a notification that the foundational item is unavailable at the source from the computer system to a user client device of the user in response to the computer system receiving an order status from the user client device that the foundational item is unavailable at the source.

16. The computer program product of claim 15, wherein a score for an item is based on a number of other items in the order having at least a threshold correlation score to the item, a correlation score for an item determined by the foundational item model.

17. The computer program product of claim 16, wherein transmitting the notification that the foundational item is unavailable at the source from the computer system to a user client device of the user in response to the computer system receiving the order status from the user client device that the foundational item is unavailable at the source comprises:
transmitting a notification identifying the foundational item and one or more additional items of the order that each have at least the threshold correlation score to the foundational item.

18. The computer program product of claim 17, wherein the notification identifies a replacement item for at least one of the additional items of the order having at least the threshold correlation score to the foundational item.

19. The computer program product of claim 12, wherein generating, by the computer system, a sequence of the items in the order based on the foundational item, each item in the order having the corresponding position in the sequence comprises:
generating a set of candidate sequences, each candidate sequence including the foundational item in a different position;
generating an expected cost for each candidate sequence, the expected cost based at least in part on a probability of the foundational item being unavailable at the source; and
selecting the sequence as a candidate sequence having a minimum expected cost.

20. A system comprising:
a processor; and
a non-transitory computer readable storage medium having instructions encoded thereon that, when executed by the processor, cause the processor to perform steps comprising:
receiving an order from a user, the order including one or more items to obtain from a source specified by the order;
identifying a foundational item from the one or more items included in the order based on scores determined for items included in the order by applying a foundational item model to the order and attributes of the items included in the order, wherein the foundational item model comprises a machine-learning model and is trained by:
retrieving training data including a plurality of training examples, each training example including: a grouping of items and attributes of items included in the grouping, and a label indicating which items of the grouping are foundational items;
applying the foundational item model to each training example of the training data to generate a predicted score for an item in the training example;
evaluating a loss function that compares the label of the training example to the predicted score; and
updating one or more parameters of the foundational item model based on the evaluated loss function;
generating a sequence of the items in the order based on the identified foundational item, each item in the order having a corresponding position in the sequence; and
generating a collection interface for presentation by a user client device to the user, the collection interface presenting the one or more items in the determined sequence indicating how a user should obtain the items from the source.
